(19) United States
(12) Patent Application Publication
(10) Pub. No.: US 2022/0233986 A1
(43) Pub. Date: Jul. 28, 2022

(54) HIGH-EFFICIENCY PARTICULATE AIR FILTER ASSEMBLY

(71) Applicant: RALPH DAVID BROWN, PALM SPRINGS, CA (US)

(72) Inventor: RALPH DAVID BROWN, PALM SPRINGS, CA (US)

(73) Assignee: VIRONAIRE INC., PALM SPRINGS, CA (US)

(21) Appl. No.: 17/189,195

(22) Filed: Mar. 1, 2021

Related U.S. Application Data
(60) Provisional application No. 63/142,273, filed on Jan. 27, 2021.

(51) Int. Cl. B01D 46/00; B01D 46/30; B01D 46/12

(52) U.S. Cl. CPC B01D 46/0023; B01D 46/0015; B01D 46/30; B01D 46/0036; B01D 2253/108; B01D 2267/40; B01D 2253/1124; B01D 2253/102; B01D 46/12; B01D 2253/25

(57) ABSTRACT

A high-efficient particulate air filter assembly including a high efficient particulate air filter for filtering the intake air as it enters an air purifying system is provided. The air filter assembly can further include a housing configured for use in an air purification system; a first prefilter positioned in the housing upstream from the particulate air filter; and an electrostatically charged substrate positioned in the housing downstream from the particulate air filter. The air filter assembly can further include a second prefilter having a paper layer; a carbon layer; a zeolite layer; a mesh layer; and a foam layer.

### FIELD

The present disclosure relates to a high-efficient particulate air filter assembly comprising a purifying filter for filtering air as it passes through the assembly.

### BACKGROUND

Air purifiers, including portable air purifiers, are used to purify the air flowing through contained areas, including clean rooms and bedrooms. Such devices generally include an air filter assembly having a particulate air filter for purifying the air. A particulate air filter is a device composed of fibrous or porous materials that can remove solid particulates, such as dust, pollen, mold, and bacteria, from the air. Some filters contain an adsorbent or catalyst, such as charcoal (carbon), to remove odors and gaseous pollutants, such as volatile organic compounds or ozone. A HEPA (high efficiency particulate air) filter is a type of air filter capable of arresting 99.95% or more of the particles in the air flowing through the system that have a particle size that is greater than or equal to 0.3 μm (microns). A variety of other types of filters are also available. But as new air purifiers are developed to address new concerns, improved high efficiency particular air filter assemblies are needed.

### SUMMARY

In various embodiments, a high-efficient particulate air filter assembly is provided. In some embodiments, the air filter assembly comprises: a housing configured for use in an air purification system; a high efficient particulate air filter positioned within the housing; a first prefilter positioned in the housing upstream from the particulate air filter; and an electrostatically charged substrate positioned in the housing downstream from the particulate air filter, wherein upstream refers to relative proximity to an air intake and downstream refers to relative proximity to an air outtake.

In some embodiments, the first prefilter is configured with a pore size sufficient to trap particles in the range of 50 microns or more. In some embodiments, the first prefilter comprises a polyester foam cloth positioned between a pair of aluminum mesh sheets. In some embodiments, the foam cloth is electrostatically charged. In some embodiments, one or both of the pair of aluminum mesh sheets is/are electrostatically charged. In some embodiments, each of the polyester foam cloth and the pair of aluminum sheets is electrostatically charged.

In some embodiments, the air filter assembly comprises a second prefilter positioned in the housing between the first prefilter and the high efficient particulate air filter is. In some embodiments, the second prefilter comprises a paper layer. In some embodiments, the paper layer comprises spun polyurethane and/or a cellulose membrane. In some embodiments, the paper layer is configured to trap particles having a particle size of about 45 microns or more.

In some embodiments, the air filter assembly comprises a carbon layer containing one or more forms of carbon. one or more forms of carbon includes carbon granules and activated carbon.

In some embodiments, the air filter assembly comprises a zeolite layer containing one or more types of zeolites. In some embodiments, the one or more types of zeolites include zeolites comprising aluminum, hydrated silicon compounds, and/or oxygen.

In some embodiments, the air filter assembly comprises one or more mesh layers configured to retain a zeolite layer and a carbon layer therebetween. In some embodiments, each of the one or more mesh layers is comprised of a synthetic polymer.

In some embodiments, the air filter assembly comprises a structured layer configured to hold a plurality of carbon granules in a carbon layer and a plurality of zeolite granules in a zeolite layer.

In some embodiments, the air filter assembly comprises a foam layer comprised of one or more of spun polyurethane, aluminum, titanium dioxide, and cellulose. In some embodiments, a surface on one or both opposing faces of the foam layer is coated with a coating comprising titanium dioxide.

In some embodiments, the high efficiency particulate air filter is a throwaway, extended-medium, dry type filter with a rigid casing enclosing a full depth of one or more pleats, wherein the high efficiency particulate air filter exhibits a minimum efficiency of 99.97% when tested with an aerosol of 0.3 micrometer diameter.

The foregoing general summary is intended to provide an overview or framework for understanding the nature and character of the embodiments disclosed herein. This summary is not intended to identify essential inventive concepts of the claimed subject matter or limit the scope of the claimed subject matter. Additional features and advantages of the embodiments disclosed herein will be set forth in the detailed description that follows, and in part will be clear to those skilled in the art from that description or recognized by practicing the embodiments described herein, including the detailed description that follows, the claims, and the appended drawings.

### BRIEF DESCRIPTION OF THE DRAWINGS

A complete understanding of the present embodiments and the advantages and features thereof will be more readily understood by reference to the following detailed description, appended claims, and accompanying drawings, wherein:

FIG. 1 shows an exploded perspective view of a high-efficient particulate air filter assembly, according to embodiments described herein;

FIG. 2 shows a front view of the air purifying filter in FIG. 1;

FIG. 3A shows a sectional view along the 3A-3A′ line in FIG. 2;

FIG. 3B shows a side view of the air purifying filter in FIG. 1;

FIG. 4A shows a front view of an exemplary air purifying system that uses the air purifying filter of FIG. 1; and

FIG. 4B shows a perspective view of an exemplary air purifying system that uses the air purifying filter of FIG. 1.

The drawings are not necessarily to scale, and certain features and certain views of the drawings may be shown exaggerated in scale or in schematic in the interest of clarity and conciseness.

### DETAILED DESCRIPTION

Reference will now be made in detail to the exemplary embodiment(s), examples of which is/are illustrated in the accompanying drawings. Whenever possible, the same reference numerals will be used throughout the drawings to refer to the same or like parts.

Before describing the exemplary embodiments, it is noted the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The specific details of the various embodiments described herein are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

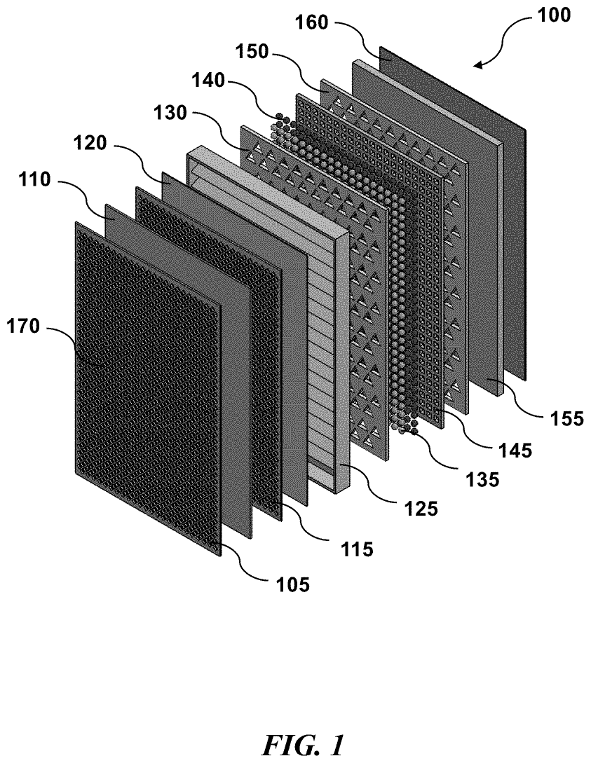

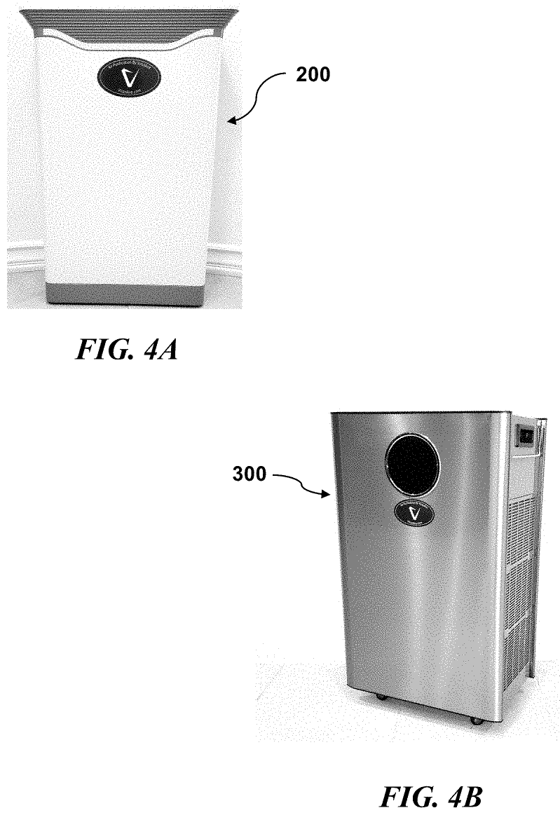

In various embodiments, as shown in FIGS. 1-3B, a high-efficient particulate air filter assembly (“assembly”) is provided. In some embodiments, the assembly is configured for use in an air purification system, such as the air purification systems shown in FIGS. 4A and 4B.

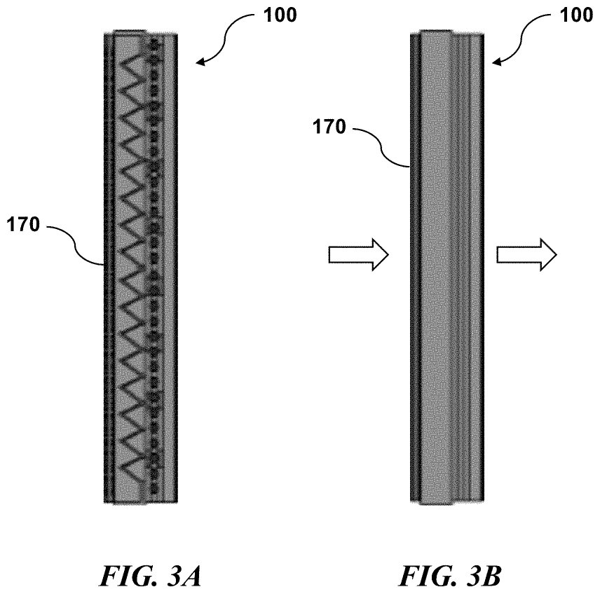

As shown in FIG. 1, the assembly 100 comprises a plurality of components. In some embodiments, the assembly 100 comprises a multilayered structure, wherein one or more layers of a plurality of the layers is distinct from the other layers. In some embodiments, the assembly 100 comprises between 3 and 15 layers, between 4 and 13 layers, more than 4 layers, more than 8 layers, more than 10 layers, at least 4 layers, at least 5 layers, at least 6 layers, at least 8 layers, at least 10 layers, 6 layers, 7 layers, 8 layers, 9 layers, 10 layers, 12 layers, etc. In any of these recited ranges, the endpoints are included and any unrecited intermediate numbers are included (e.g., between 3 and 15 layers includes 4-14; 6-10; 7-8). In some embodiments, the assembly 100 is configured such that the air flow should be essentially perpendicular or transverse to the surface 170 of the outermost layer 105, as indicated by the arrows in FIG. 3B.

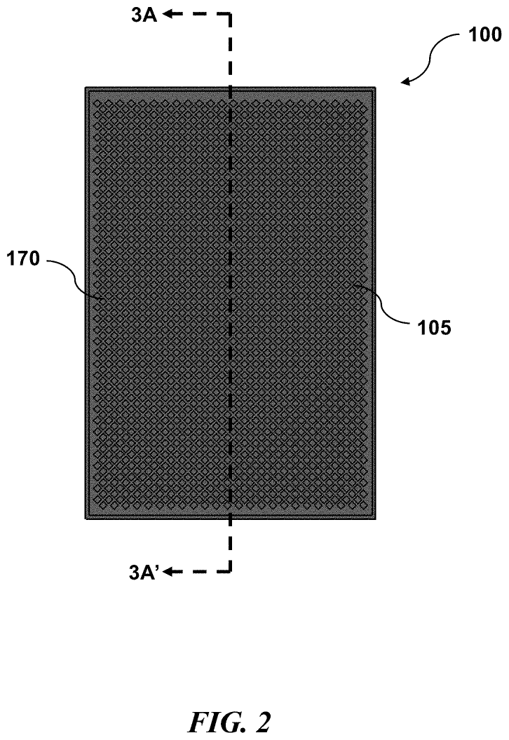

In some embodiments, the assembly 100 comprises a rectangular prism shape. In some embodiments, the assembly 100 comprises a rectangular prism shape having two opposing faces and four sidewalls, wherein the surface area on each of the two opposing faces is substantially larger and proportionally greater than the surface area of each of the four sidewalls. In some embodiments, for example, the two opposing faces and the four sidewalls are substantially the same as the proportions for those surfaces as shown in front view in FIG. 2 and the side view in FIG. 3B. Other suitable shapes and sizes are contemplated. In such embodiments, the suitable size and shape will be determined based on the size and shape of the filter housing in the air purification systems the assembly 100 is manufactured for.

In some embodiments, the assembly 100 comprises a particulate air filter 125. Any suitable air filter can be utilized. In some embodiments, for example, the particulate air filter 125 is a high efficiency particulate air (HEPA) filter, which is a throwaway, extended-medium, dry type filter with a rigid casing enclosing the full depth of the pleats. The filter shall exhibit a minimum efficiency of 99.97% when tested with an aerosol of 0.3 micrometer diameter, according to the U.S. Department of Energy Technical Standard (DOE-STD-3020-2015; June 2015). Any suitable HEPA filter may be utilized. In some embodiments, for example, the particulate air filter 125 is a H13 HEPA filter. In some embodiments, the particulate air filter 125 has a rating of effectiveness according to the minimum efficiency reporting value (MERV) in the range of 9-12, which is configured to contain impurities having a minimum particle size in the range of 3.0-1.0 micrometer, or more preferably in the range of 13-16, which is configured to contain impurities having a minimum particle size in the range of 1.0-0.3 microns.

In some embodiments, the assembly 100 comprises a pre-filter. In some embodiments, the pre-filter is configured with a pore size sufficient to trap larger particles in the range of 50 microns or more. The prefilter can include one or more elements. In some embodiments, the prefilter comprises polyester foam cloth 110 positioned between a pair of aluminum mesh sheets 105, 115. In some embodiments, the foam cloth 110 is electrostatically charged. In some embodiments, one or both of the aluminum sheets 105, 115 is/are electrostatically charged. In some embodiments, each of the polyester foam cloth 110 and the aluminum sheets 105, 115 is electrostatically charged. The electrostatic charge can attract particles, regardless of their size, which assists in prolonging the life of one or more layers positioned behind (from front to back in terms of air flow) the prefilter. In some embodiments, the pre-filter prolongs the life of the HEPA filter.

In some embodiments, the assembly 100 comprises one or more additional prefilters. For example, in some embodiments, the assembly 100 includes a protective paper layer 120 between the first prefilter (105, 110, 115) and the HEPA filter 125. The paper layer 120 can comprise any suitable materials, including, for example, spun polyurethane and paper (cellulose), or equivalents thereof. In some embodiments, the paper comprises a cellulose membrane. As a pre-filter, the paper layer 120 is configured to contain impurities having a predetermined particle size to prolong the life of the HEPA filter 125. In some embodiments, the paper layer 120 is configured to trap particles having a particle size of about 45 microns or more.

In some embodiments, the assembly 100 comprises one or more mesh layers 130, 150. In such embodiments, each of the one or more mesh layers 130, 150 is comprised of a polymer. In some embodiments, each of the one or more mesh layers is comprised of a synthetic polymer, including, for example, nylon or a polymer having similar properties. In some embodiments, each of the one or more mesh layers 130, 150 is configured to retain one or more component layers therebetween. For example, in FIG. 1, the mesh layers 130, 150 are configured to retain a zeolite layer 135 and a carbon layer 140 in position therebetween.

In some embodiments, the assembly 100 comprises a zeolite layer 135 containing one or more types of zeolites. In some embodiments, the one or more types of zeolites are made up of aluminum, hydrated silicon compounds, and oxygen. One of ordinary skill in the art would appreciate that zeolites are commonly used as an adsorbent, and zeolites have the ability to trap toxic gases and odors such as formaldehyde, ammonias, and carbon monoxide. The one or more types of zeolites can be naturally or synthetically formed. Natural zeolites include, for example, the non-fibrous compounds found in volcanic rock.

In some embodiments, the assembly 100 comprises a carbon layer 140 containing one or more forms of carbon. In such embodiments, the carbon can be carbon granules, activated carbon, or any other form of carbon that is useful for eliminating impurities in air. In some embodiments, the carbon layer 140 comprises activated carbon. In some embodiments, the activate carbon is obtained from charcoal created through the combustion of hard woods or other organic materials. In some embodiments, the carbon layer 140 is configured to reduce or eliminate the presence of any unwanted odors, chemicals, and gasses in the air flow.

In some embodiments, the assembly 100 comprises a structured layer 145 to hold the carbon granules in the carbon layer 140 and the zeolite granules in the zeolite layer 135. In some embodiments, the structured layer 145 comprises a honeycomb-pattern of impressions on the surface(s) of its front and/or rear faces. Other structured layers, including those with different patterns on the surface (e.g., dimples, grooves, other shaped impressions), are contemplated. The structured layer 145 can be made out of any suitable material. In some embodiments, the structured layer 145 is comprises cellulose or a suitable alternative having similar properties.

In some embodiments, the assembly 100 comprises a foam layer 155. The foam layer 155 can be comprised of any suitable material. For example, in some embodiments, the foam layer 155 comprises one or more of spun polyurethane, aluminum, titanium dioxide and paper (cellulose). In some embodiments, the surface on one or both opposing faces of the foam layer 155 is coated. In some embodiments, the surface of one face of the foam layer 155 is more heavily coated than the surface of the opposing face (i.e., it has a thicker layer). In some embodiments, the coating comprises one or more chemical reagents. For example, in some embodiments, titanium dioxide is used in the coating. One of ordinary skill in the art would appreciate that titanium dioxide can undergo a photocatalytic reaction in the presence of UV radiation, which provides a high rate of disinfection. In some embodiments, the foam acts as a cold catalytic filter for the photocatalytic reaction under UV radiation.

The high-efficient particulate air filter assembly 100 is configured for use inside of an air purification apparatus. In some embodiments, the assembly 100 is configured for use in a VironAire iVA1000 Air Purifier for home use, or an iVA2500 Air Purifier for commercial locations. Although the use of the assembly 100 in one of these specific apparatuses is contemplated, the use of the assembly 100 is not limited to those specific apparatuses. Other shapes and sizes for the assembly 100 are contemplated. As such, in some embodiments, the assembly 100 is configured for alternative air purification apparatuses.

One of ordinary skill in the art would appreciate that in fluid dynamics, an orifice restricts the flow of gas or liquid via its smaller opening. In some embodiments, the assembly 100 comprises a plurality of layers, and the respective pore sizes in each layer may be the same or different, and the pore sizes present in each individual layer may be the same or different. In some embodiments, the pore sizes are homogeneously spaced throughout the surfaces of one or more of the plurality of layers, or in each of the layers. In such embodiments, the speed of the air flow through the assembly 100 acts under Bernoulli's equations to increase pressure upstream, which increases efficiencies of the components within the assembly. For example, when a fluid passes through the orifice, its pressure builds up in the upstream direction. However, as the fluid is forced to converge in order to pass through the orifice, the velocity increases and the fluid pressure decreases. In some embodiments, the air flow reaches its point of maximum convergence as it proceeds downstream. The vena contracta is where the velocity reaches its maximum and the pressure reaches its minimum. Beyond that position, the flow expands, the velocity falls, and the pressure increases.

### EXAMPLES

Inventive Examples are described below in detail to illustrate the various embodiments disclosed herein. Also described in detail are Comparative Examples, which are provided for testing and comparison to the Inventive Examples with respect to their respective air purifying function. The Inventive Examples according to embodiments described herein include a high efficiency particulate air filter chamber (“HEPAFC”). The Comparative Examples include a standard, off-the-shelf HEPA H13 filter (“SHEPA”).

For the testing method described below, the testing components include: (1) three HEPAFC filters with a surface area of 180 square inches each; (2) three SHEPA filters with a surface area of 180 square inches each; (3) sealed test chamber measuring 6′×6′×6′ equaling 216 cubic feet volume; (4) smoke canister producing inhalable particles of 2.5 microns in size or less (“PM2.5”); (5) iVA1000 air purifier with fan speed of 100 cfm; (6) PA-II-SD air quality real-time PM2.5 sensor; and (7) compressed air.

Testing method: in a test chamber at an ambient air temperature of 75 degrees Fahrenheit, relative humidity of 22%, and barometric pressure of 30.06, the filter (HEPAFC or SHEPA) under test was fitted into the iVA1000 unit and placed in the test chamber. The test chamber was purged to non-detectable levels of PM2.5 (0 μg/m3) using compressed air. PM2.5 from the smoke canister was slowly titrated into the test chamber until 100 μg/m3 achieved. After titration, 5 minutes was allowed to elapse to verify 100 μg/m3 was stable and maintained. Purging or smoke titration applied as necessary to adjust to 100 μg/m3 after the 5-minute period. The iVA1000 was switched on and allowed to run for 120.0 seconds (2 minutes), after which PM2.5 was measured by the PA-II-SD. A total of 3 tests per filter was run. A new, unused filter was inserted into the iVA1000 after each test run to ensure a nominal baseline.

The test results are shown in Table 1, below.

| | Run | Result | PM2.5 |
|---|---|---|---|
| Filter | Number | PM2.5 μg/m3 | Reduction |
| HEPAFC | 1 | 35 | 65% |
| (Inventive | 2 | 35 | 65% |
| Examples) | 3 | 37 | 63% |
| SHEPA | 1 | 42 | 58% |
| (Comparative | 2 | 41 | 59% |
| Examples) | 3 | 43 | 57% |

As shown above in Table 1, the HEPAFC (Inventive Examples) demonstrated an average PM2.5 reduction of 64.7 μg/m3 from the 100 μg/m3 initial condition, and the SHEPA (Comparative Examples) demonstrated an average PM2.5 reduction of 58 μg/m3. The testing results show that HEPAFC (Inventive Examples) was 15% more efficient at removing PM2.5 than SHEPA (Comparative Examples).

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

I/We claim:

1. A high-efficient particulate air filter assembly, comprising:
a housing configured for use in an air purification system;
a high efficient particulate air filter positioned within the housing;
a first prefilter positioned in the housing upstream from the particulate air filter; and
an electrostatically charged substrate positioned in the housing downstream from the particulate air filter;
wherein upstream refers to a relative proximity to an air intake and downstream refers to a relative proximity to an air outtake.

2. The air filter assembly of claim 1, wherein the first prefilter is configured with a pore size sufficient to trap particles in the range of 50 microns or more.

3. The air filter assembly of claim 1, wherein the first prefilter comprises a polyester foam cloth positioned between a pair of aluminum mesh sheets.

4. The air filter assembly of claim 3, wherein the foam cloth is electrostatically charged.

5. The air filter assembly of claim 3, wherein one or both of the pair of aluminum mesh sheets is/are electrostatically charged.

6. The air filter assembly of claim 3, wherein each of the polyester foam cloth and the pair of aluminum sheets is electrostatically charged.

7. The air filter assembly of claim 1, further comprising a second prefilter positioned in the housing between the first prefilter and the high efficient particulate air filter.

8. The air filter assembly of claim 7, wherein the second prefilter comprises a paper layer.

9. The air filter assembly of claim 8, wherein the paper layer comprises spun polyurethane and/or a cellulose membrane.

10. The air filter assembly of claim 8, wherein the paper layer is configured to trap particles having a particle size of about 45 microns or more.

11. The air filter assembly of claim 1, further comprising a carbon layer containing one or more forms of carbon.

12. The air filter assembly of claim 12, wherein the one or more forms of carbon includes carbon granules and activated carbon.

13. The air filter assembly of claim 1, further comprising a zeolite layer containing one or more types of zeolites.

14. The air filter assembly of claim 13, wherein the one or more types of zeolites include zeolites comprising aluminum, hydrated silicon compounds, and/or oxygen.

15. The air filter assembly of claim 1, further comprising one or more mesh layers configured to retain a zeolite layer and a carbon layer therebetween.

16. The air filter assembly of claim 15, wherein each of the one or more mesh layers is comprised of a synthetic polymer.

17. The air filter assembly of claim 1, further comprising a structured layer configured to hold a plurality of carbon granules in a carbon layer and a plurality of zeolite granules in a zeolite layer.

18. The air filter assembly of claim 1, further comprising a foam layer comprised of one or more of spun polyurethane, aluminum, titanium dioxide, and cellulose.

19. The air filter assembly of claim 18, wherein a surface on one or both opposing faces of the foam layer is coated with a coating comprising titanium dioxide.

20. The air filter assembly of claim 1, wherein the high efficiency particulate air filter is a throwaway, extended-medium, dry type filter with a rigid casing enclosing a full depth of one or more pleats, wherein the high efficiency particulate air filter exhibits a minimum efficiency of 99.97% when tested with an aerosol of 0.3 micrometer diameter.
